(19) United States
(12) Patent Application Publication
(10) Pub. No.: US 2019/0200772 A1
(43) Pub. Date: Jul. 4, 2019

(54) SWAY-YAW MOTION DEVICE AND CHAIR ASSEMBLY WITH THE SAME

(71) Applicant: CJ 4DPLEX CO., LTD., Seoul (KR)

(72) Inventors: Taeyoung KU, Goyang-si Gyeonggi-do (KR); Jae Sung CHOI, Goyang-si Gyeonggi-do (KR); Jong Su CHOI, Seoul (KR)

(21) Appl. No.: 16/298,624

(22) Filed: Mar. 11, 2019

Related U.S. Application Data
(63) Continuation of application No. PCT/KR2017/009844, filed on Sep. 8, 2017.

(30) Foreign Application Priority Data
Sep. 9, 2016 (KR) 10-2016-0116621
Dec. 5, 2016 (KR) 10-2016-0164499

(51) Int. Cl. A47C 15/00; A47C 1/124; A47C 3/025; A47C 3/026; A63G 31/02; F16H 21/50; G05G 9/047

(52) U.S. Cl. CPC A47C 15/004; A47C 1/124; A47C 3/0251; A63G 31/16; A63G 31/02; F16H 21/50; G05G 9/047; A47C 3/026

(57) ABSTRACT

Disclosed herein are a sway-yaw motion device and a chair assembly with the same, which can provide an audience with various motion effects by moving a motion chair by various degrees of freedom. The sway-yaw motion device and the chair assembly can additionally provide various motions on the plane by adding a swaying motion, which is a linear motion on the plane, and a yawing motion, which is a rotary motion on the plane, to a pitching motion, a rolling motion and a heaving motion, which are provided generally. Particularly, the present invention relates to a sway-yaw motion device and a chair assembly with the same, which can provide swaying and yawing effects at the same time according to actuation of a driving part, for instance, according to an angle control of a crank arm, as well as provide the swaying motion and the yawing motion individually.

### CROSS REFERENCE TO RELATED APPLICATION

This present application is a continuation of International Application Number PCT/KR2017/009844 filed on Sep. 8, 2017 which is based upon and claims the benefit of priority to Korean Patent Application No. 10-2016-0116621 filed on Sep. 9, 2016 and 10-2016-0164499 filed on Dec. 5, 2016 in the Korean Intellectual Property Office. The disclosures of the above-listed applications are hereby incorporated by reference herein in their entirety.

### TECHNICAL FIELD

The present invention relates to a sway-yaw motion device and a chair assembly with the same, and more particularly, to a sway-yaw motion device and a chair assembly with the same, which can provide an audience with various motion effects by moving a motion chair by various degrees of freedom.

The motion device according to the present invention can additionally provide various motions on the plane by adding a swaying motion, which is a linear motion on the plane, and a yawing motion, which is a rotary motion on the plane, to a pitching motion, a rolling motion and a heaving motion, which are provided generally. Particularly, the present invention relates to a sway-yaw motion device and a chair assembly with the same, which can provide swaying and yawing effects at the same time according to actuation of a driving part, for instance, according to an angle control of a crank arm, as well as provide the swaying motion and the yawing motion individually.

### BACKGROUND ART

In a movie theater, which is a facility to show images, images are conventionally projected onto a screen such that an audience can see the images. However, recently, in order to add reality to image contents, 3D images are distributed and shown and various special effects are provided.

For instance, in the case of an explosion in an action movie, back blast effect is expressed by wind such that an audience can feel it. Moreover, when foods come on in a cinematic screen, food smells corresponding to the foods may be provided.

Technology that provides such effects is called 4D meaning that one technique is added to 3D images, and in more correctly, such technology is called 4D, which is a type that various special effects, such as liquid injection, odorization, seismic excitation, and so on, are added to digital 2D or 3D image screens. 4D technology may be realized using devices installed on a chair, on which an audience sits on, or in a movie theater.

The chair for audience to realize 4D is called a motion chair, and may have about 20 special effects including motion effects by chair motions that the chair moves in back and forth, right and left and up and down directions, such as a mice tickler effect that a device in the chair tickles the legs, back tic effect that a device in the chair taps on the back part, a buttock effect that a device in the chair taps on the buttocks, shaker effects with vibrations of four types, and a drop effect, and environment effects, such as water injection, face air and neck air, wind, smoke, lighting, and so on.

The motion chair generally provides motion-related effects, such as pitching for rotating in the back-and-forth direction, rolling for rotating in the right-and-left direction, and heaving for moving in the up-and-down direction.

As a related art, Korean Patent No. 10-1485269 discloses an ‘actuator of a chair assembly for 4D theater’ (hereinafter, called ‘related art’), which can prevent vibration or noise caused by load disturbance generated while a rotary motion is converted into a linear motion.

The related art basically provides the motions of pitching, rolling and heaving described above, but most of motion chairs including the related art provide only the basic several motions.

Therefore, the conventional motion chairs have a disadvantage in that it cannot offer sufficient motion effects to audiences because they offer some of motions on space.

### DISCLOSURE

### Technical Problem

Accordingly, the present invention has been made in view of the above-mentioned problems occurring in the prior art, and it is an object of the present invention to provide a sway-yaw motion device and a chair assembly with the same, which can provide an audience with various motion effects by moving a motion chair by various degrees of freedom.

It is another object of the present invention to provide a sway-yaw motion device and a chair assembly with the same, which can add a swaying motion, which is a linear motion on the plane, to a pitching motion, a rolling motion and a heaving motion, which are provided generally.

It is a further object of the present invention to provide a sway-yaw motion device and a chair assembly with the same, which can realize motions with various degrees of freedom on space.

### Technical Solution

To accomplish the above object, according to the present invention, there is provided a sway-yaw motion device including: a guide part; a driving part arranged in an inner space of the guide part; and a driven part selectively carrying out motions according to one of a swaying mode, a yawing mode and a swaying-yawing composite mode by the driving part.

Here, the driving part makes the driven part carry out a linear motion in a parallel direction to a longitudinal axis of the guide part in the case of a swaying mode, and makes the driven part carry out eccentric rotation on a vertical axis of the guide part in the case of a yawing mode.

According to an embodiment, the guide part comprises at least one guide module for inducing the swaying mode and the yawing mode of the driven part. In this instance, the guide module includes: a guide rail mounted in the inner space of the guide module; and guide wheels, which support the load of the driven part and move in contact with the guide rail.

Moreover, the guide wheel comprises a front wheel located on the front surface of the guide rail and a rear wheel located on the rear surface of the guide rail.

Furthermore, a guide rod for connecting the front wheel and the rear wheel with each other is inserted into the guide rail.

According to an embodiment, a pair of guide modules are arranged with line symmetry on the basis of the width direction from the center of the guide part.

In the meantime, the driving part according to the first embodiment includes: a crank shaft; crank arms connected from an end portion of the crank shaft in the horizontal direction along one side of the guide part; and a crank pin formed to extend vertically from the crank arm and connected to the driven part.

Here, the crank arms are formed by at least two pieces, which are linked with each other.

Additionally, the crank arms move the driven part through an angular variation of the crank arms relative to the width direction of the guide part so as to convert the swaying mode into the yawing mode and the yawing mode into the swaying mode.

In addition, in the case that the crank arms are actuated at more than a predetermined angle range relative to the width direction of the guide part, the swaying mode and the yawing mode with respect to the driven part are carried out at the same time.

According to an embodiment, the driving part is operated by being connected with a sway-yaw actuator arranged inside the motion device.

Here, the sway-yaw actuator operates in correspondence with a control modes including at least one of: a swaying mode that the driven part reciprocates in a straight line within a range of a first set angle of the crank arm included in the crank module; a yawing mode that the driven part shakes horizontally within a range of a second set angle; and a composite mode that the driven part carries out the swaying motion and the yawing motion at the same time within a range of a third set angle.

Moreover, the driving part according to another embodiment includes a power generation part and a shaft, which is connected to the power generation part and moves to be parallel to the longitudinal direction of the guide part.

In this instance, the shaft is connected with a connection member downwardly extending from the driven part so as to offer linear driving power to the driven part.

The driving part according to another embodiment may be, for instance, a cylinder-drive driving part according to a second embodiment, a linear motor-drive driving part according to a third embodiment, and a screw motor-drive driving part according to a fourth embodiment.

The present invention provides a chair assembly with the sway-yaw motion device.

The chair assembly with the sway-yaw motion device according to an embodiment of the present invention includes: a driven part having a seat for allowing an audience to sit thereon; a guide part arranged below the driven part; a driving part arranged in an inner space of the guide part to make the driven part selectively carry out motions according to one of a swaying mode, a yawing mode and a swaying-yawing composite mode; and a lower plate for supporting the guide part, wherein at least two actuators for inducing pitching, rolling and heaving motions are arranged on the lower plate.

Here, the driving part makes the driven part carry out a linear motion in a parallel direction to a longitudinal axis of the guide part in the case of a swaying mode, and makes the driven part carry out eccentric rotation on a vertical axis of the guide part in the case of a yawing mode.

### Advantageous Effects

As described above, the sway-yaw motion device and the chair assembly with the same according to the present invention can provide an audience with various motion effects by moving the motion chair by various degrees of freedom.

Moreover, the sway-yaw motion device and the chair assembly with the same according to the present invention can additionally provide the swaying motion, which is a linear motion on the plane, to the pitching motion, the rolling motion and the heaving motion, which are provided generally to a driven part, for instance the motion chair. Therefore, the sway-yaw motion device and the chair assembly with the same according to the present invention can offer more realistic motion effects to the audience.

Furthermore, the sway-yaw motion device and the chair assembly with the same according to the present invention can realize more free motions of the driven part (motion chair) on space by additionally providing the swaying motion and the yawing motion, which is a rotary motion.

Particularly, the sway-yaw motion device and the chair assembly with the same according to the present invention can realize the swaying motion and the yawing motion at the same time according to movements of the driving part, for instance, when the crank arm moves at more than a predetermined angle range, inside a device.

Finally, the present invention can provide the audience with the optimum motion effects.

Therefore, the sway-yaw motion device and the chair assembly with the same according to the present invention can improve reliability and competitiveness in the fields of 4D and special effects, such as motion effects of motion chairs for movie theaters, and in similar or relevant fields.

### DESCRIPTION OF DRAWINGS

FIG. 1 is a perspective view showing a sway-yaw motion device and a chair assembly with the same according to an embodiment of the present invention.

FIG. 2 is a perspective view of a guide part according to an embodiment of the present invention.

FIG. 3 is a view of a guide wheel according to an embodiment of the present invention.

FIG. 4 is a view showing a stop mode of the guide part and a driven part according to an embodiment of the present invention.

FIG. 5 is a view showing the guide part and the driven part in a swaying mode according to an embodiment of the present invention.

FIG. 6 is a view showing the guide part and the driven part in a yawing mode according to an embodiment of the present invention.

FIGS. 7A and 7B are a conceptual diagram of a driving part according to a first embodiment of the present invention illustrated in FIG. 2.

FIGS. 8A and 8B are a conceptual diagram of a driving part according to a second embodiment of the present invention.

FIGS. 9A and 9B are a conceptual diagram of a driving part according to a third embodiment of the present invention.

FIGS. 10A and 10B are a conceptual diagram of a driving part according to a fourth embodiment of the present invention.

### MODE FOR INVENTION

Hereinafter, a sway-yaw motion device and a chair assembly with the same according to embodiments of the present invention are described in detail with reference to the accompanying drawings. The embodiments to be described are provided in order for those skilled in the art to easily understand the technical spirit of the present invention, and the present invention is not restricted by the embodiments. Furthermore, contents represented in the accompanying drawings have been diagrammed in order to easily describe the embodiments of the present invention, and the contents may be different from forms that are actually carried out.

In the following description, an X-axis may mean a width direction of a sway-yaw motion device and a guide part, a Y-axis may mean a longitudinal direction of the sway-yaw motion device and the guide part, and Z-axis may mean a height direction of the sway-yaw motion device and the guide part.

For your reference, pitching may mean a motion for rotating in a back-and-forth direction based on the Y-axis (horizontal axis), rolling may mean a motion for rotating in a right-and-left direction based on the X-axis (back-and-forth axis), and heaving may mean a motion for reciprocating in the up-and-down direction (vertical direction) based on the Z-axis (vertical axis).

Moreover, in this specification, swaying may mean a motion for swaying from side to side in the Y-axis direction, yawing may mean a horizontal shaking for rotating on the Z-axis. Especially, in this specification, yawing may include a horizontal movement for performing an eccentric rotation based on the Z-axis, and it is caused from a characteristic shape of a guide module. A composite mode of swaying and yawing may mean that the motion for swaying from side to side in the Y-axis direction and the eccentric rotation based on the Z-axis are generated at the same time or consecutively.

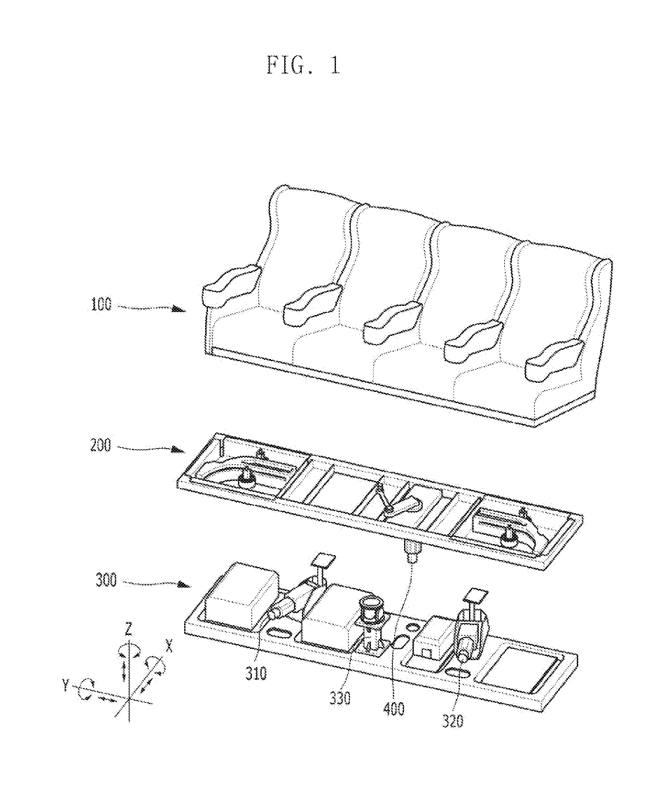

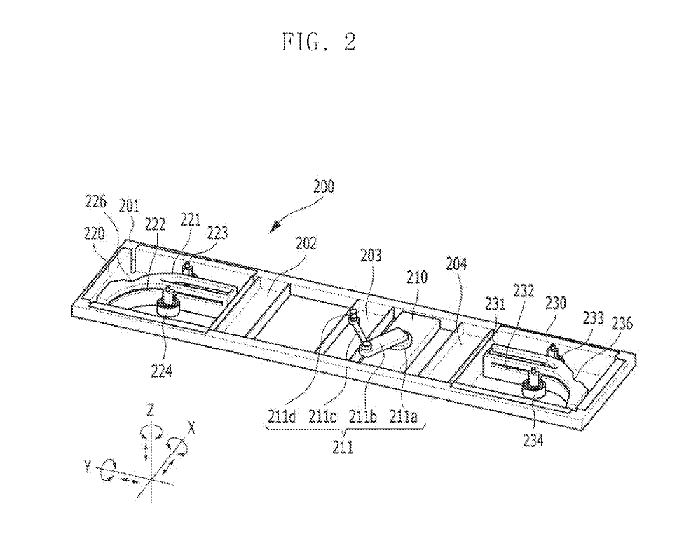

FIG. 1 is a perspective view showing a sway-yaw motion device and a chair assembly with the same according to an embodiment of the present invention, and FIG. 2 is a perspective view of a guide part according to an embodiment of the present invention.

Referring to FIG. 1, the sway-yaw motion device according to the present invention includes: a guide part 200; a driving part 210 disposed in an inner space of the guide part 200; and a driven part 100 for selectively carrying out an action according to one of a swaying mode, a yawing mode and a swaying-yawing composite mode by the driving part 210.

The sway-yaw motion device may include the guide part 200 and the driving part 210 mounted on the guide part 200. The driven part 100 may be arranged adjacent to the guide part 200. Components of the guide part 200 and the driving part 210 are organically combined to offer various effects to the driven part 100. The driven part 100 is an element moving in various degrees of freedom by the guide part 200 and may be arranged on the upper part of the guide part 200.

As shown in FIG. 1, a seat for a motion chair may be mounted at the driven part 100. Additionally, a lower plate 300 may be mounted below the guide part 200. The motion device, the seat, and the lower plate 300 compose a chair assembly. Hereinafter, as shown in FIGS. 2 to 6, for convenience's sake, the lower plate and the seat for the motion chair will be omitted, and the present invention will be described focusing on the motion device.

The guide part 200 has a framework basically including a frame 201 and a plurality of supporters 202, 203 and 204. The motion device is configured by arranging the driving part 210 and guide modules 220 and 230 on the framework. The supporters 202, 203 and 204 are arranged to increase a structural intensity of the frame 201, and may be made of a steel-like material. However, the material is exemplary, and the supporters are not limited to the form and the number illustrated in the drawing. For instance, in second, third and fourth embodiments, which will be described later, the supporter 203 located near to the driving part 210 will be omitted. It is preferable that the frame 201 and the supporters 202, 203 and 204 be formed integrally with each other. Because vibration may occur on the driving part 210 and the guide modules 220 and 230 during the operation of the motion device, constituent elements seated on the frame 201 are preferably fastened with one another in stability by welding, brazing or bolting in order to secure durability.

The motion device according to the present invention is characterized in that the driving part 210 makes the driven part do a linear motion in a parallel direction to the longitudinal axis of the guide part 200 and makes the driven part do an eccentric rotation, namely, a curvilinear motion, based on the vertical axis of the driven part. Here, the linear motion may mean a swaying motion and the curvilinear motion may mean a yawing motion. In the present invention, the curvilinear motion may be carried out after the linear motion is carried out.

In order to achieve the above motions, the motion device according to the present invention includes the guide modules, which are disposed inside the guide part, and each of which has guide rails of a unique form.

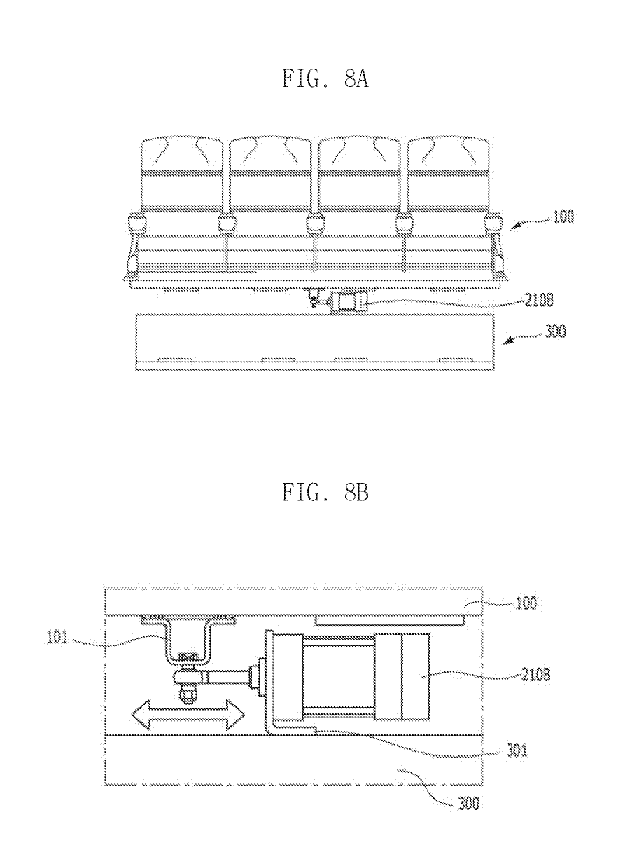

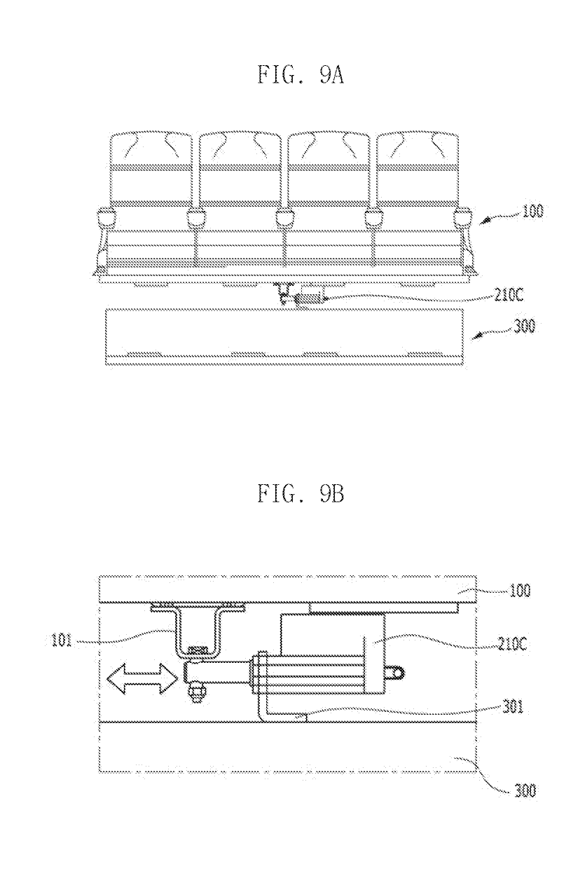

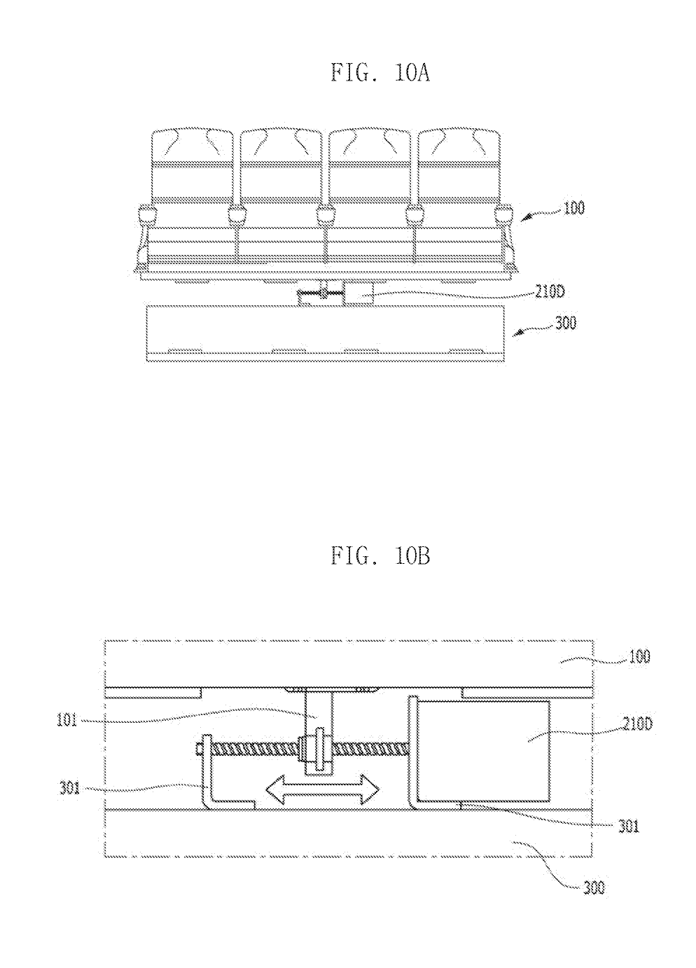

Moreover, in order to achieve the above motions, the motion device may include a crank-drive driving part according to a first embodiment illustrated in FIGS. 1 to 7B, a cylinder-drive driving part according to a second embodiment illustrated in FIGS. 8A and 8B, a linear motor-drive driving part according to a third embodiment illustrated in FIGS. 9A and 9B, or a screw motor-drive driving part according to a fourth embodiment illustrated in FIGS. 10A and 10B.

The crank-drive driving part according to the first embodiment will be first described, and then, the driving parts according to the second embodiment to the fourth embodiment will be described in detail focusing on differences between the first embodiment and the second to fourth embodiments.

In detail, the driving part 210A according to the first embodiment includes a crank module 211. Here, the crank module includes: a crank shaft 211a; crank arms 211b and 211c horizontally connected along one side of the guide part 200 from an end portion of the crank shaft 211a; and a crank pin 211d, which extends vertically from the crank arms 211b and 211c to be connected to the driven part 100.

According to an embodiment, the crank arms 211b and 211c may be formed by at least two pieces, which are linked with each other. For instance, as shown in FIG. 2, the crank arms 211b and 211c may be a first piece 211b and a second piece 211c. The first piece 211b has an end connected with the crank shaft 211a and the other end connected with the second piece 211c, and the second piece 211c has an end connected with the first piece 211b and the other end connected with the crank pin 211d.

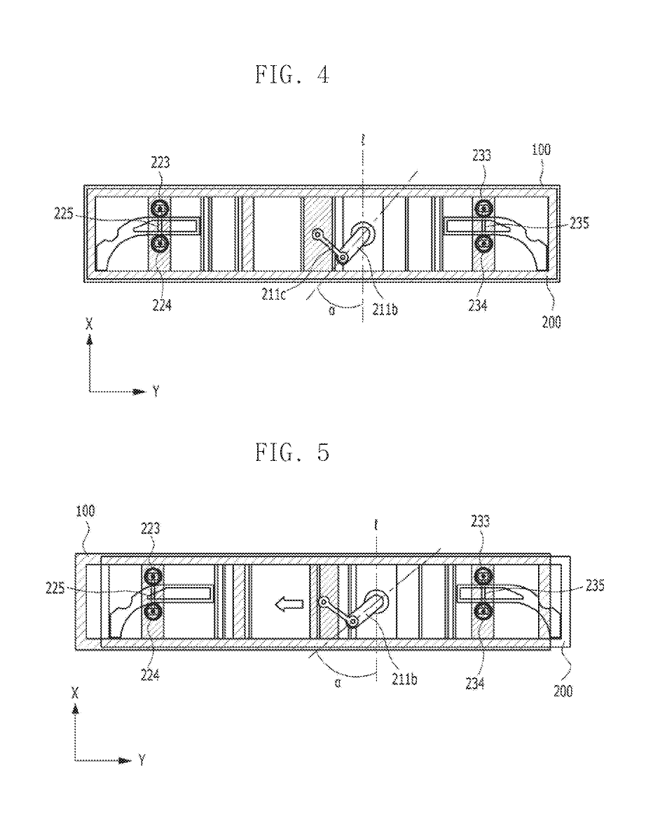

Therefore, the crank arms 211b and 211c move the driven part 100 through an angular variation of the crank arms 211b and 211c relative to the width direction of the guide part 200 so as to convert the swaying mode into the yawing mode and the yawing mode into the swaying mode. Here, the angular variation of the crank arms 211b and 211c relative to the width direction of the guide part 200 may be understood as an angular variation of the crank arms 211b and 211c on the basis of a virtual reference line 1 of FIG. 4. Furthermore, in the case that the crank arms 211b and 211c are actuated at more than the predetermined angle range (or specific angle point) relative to the width direction (or line ‘1’) of the guide part 200, the swaying mode and the yawing mode with respect to the driven part 100 may be carried out at the same time.

As shown in FIG. 2, in the first embodiment, the driving part 210 is arranged to deviate from the center of the guide part 200.

The guide part 200 includes at least one guide module, which is arranged side by side with the driving part 210 to induce the swaying mode and the yawing mode of the driven part 100.

Moreover, the guide module includes: a guide rail mounted in an inner space of the guide module; and guide wheels, which support the load of the driven part 100 and move in contact with the guide rail. The guide wheel includes a front wheel located on the front surface of the guide rail and a rear wheel located on the rear surface of the guide rail. Furthermore, the guide rail includes a guide hole formed in the side thereof. Additionally, a guide rod for connecting the front wheel and the rear wheel with each other is inserted into the guide hole.

The guide module according to an embodiment of the present invention may include a first guide module 220 and a second guide module 230. Because the first guide module 220 and the second guide module 230 actually have the same internal components, for convenience's sake, the guide module will be described focusing on the first guide module 220.

A first guide rail 221 is arranged inside the first guide module 220, and is in the form of a scythe with a long handle when it is seen from the top. In more detail, the first guide rail 221 has a straight line form at a portion positioned near to the driving part 210 to carry out the swaying mode (linear motion) and a curved form at a portion positioned away from the driving part 210 to carry out the yawing mode (curvilinear motion).

When the first guide rail 221 is seen from the top, curved parts with which the guide wheels get in contact are formed at the front and the rear of the guide rail. One of the curved parts is formed to have a radius with a uniform curvature and the other one is formed to have a radius with an ununiform curvature. Therefore, the motion device according to the present invention can provide a natural yawing motion.

The first guide rail 221 has a first guide hole 222. Here, like the first guide rail 221, the first guide hole 222 also has a straight line zone and a curved zone.

When the first guide rail 221 is seen in the X-axis direction from the first guide wheels 223 and 224, assuming that the wheel passing the front surface of the first guide rail 221 is a first front wheel 224 and the wheel passing the rear surface of the first guide rail 221 is a first rear wheel 225, the first front wheel 224 and the first rear wheel 223 are connected with each other by a first guide rod 225.

When the crank module 211 is operated, the first guide wheels 223 and 224 move along the first guide hole 222 formed in the first guide rail 221 so as to carry out the swaying mode (linear motion) and the yawing mode (curvilinear motion). In more detail, because a distance of the motion, namely, a working range, is determined according to a working angle of the crank arm in the crank module 211, when the working angle of the crank arm is small, the first guide wheels 223 and 224 moves only within a range of the straight line zone of the first guide hole 222 such that the driven part 100 moves in the swaying motion. Differently from the above, when the working angle of the crank arm is large, the first guide wheels 223 and 224 can move to the curved zone of the first guide hole 222. Moreover, based on one cycle that the crank arm rotates according to the angle range that the crank arm is workable, the swaying motion and the yawing motion can be carried out at the same time. Conversion in working modes according to angles of the crank arm will be described later in detail.

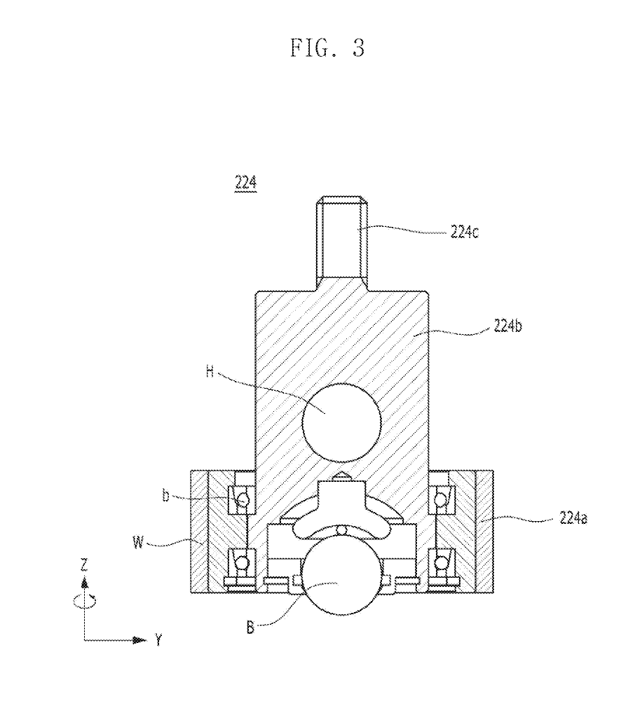

FIG. 3 is a view of the guide wheel according to an embodiment of the present invention.

According to the embodiment of the present invention, the guide wheel may include a load supporting part for supporting load of the driven part, a rod supporting part to which the guide rod is connected, and a fixing pin which is fixed in contact with the driven part.

In detail, referring to FIG. 3, the guide wheels may be ball transfers of an outer wheel rotation type. The guide wheels support the load of the driven part 100 and serve to rotate and move the outer wheels along the guide rails 221. The guide wheel includes the load supporting part 224a, and in this instance, a ball B getting in contact with the bottom surface of the guide part, an outer wheel W, which is located on the outer part of the ball B to rotate in contact with the guide rail 221, and a ball bearing b interposed between the ball B and the outer wheel W may be formed. The ball B and the outer wheel W can minimize friction force generated during the operation of the motion device. The rod supporting part 224b through which the guide rod 225 passes is arranged on the upper part of the load supporting part 224a, and the fixing pin 224c which is fixed to the driven part 100 in contact with the driven part 100 is arranged on the upper part of the rod supporting part 224b.

The second guide module 230 has the same internal components as the first guide module 220.

In summary, there are two guide modules, namely, the first guide module and the second guide module, arranged at both sides of the driving part sandwiched in between the two guide modules, and the two guide rails 221 and 231 of the two guide modules 220 and 230 are also arranged symmetrically at both sides of the guide part. The first guide module 220 and the second guide module 230 is fixed on the frame 201 of the guide part 200 to support the lower end of the driven part 100.

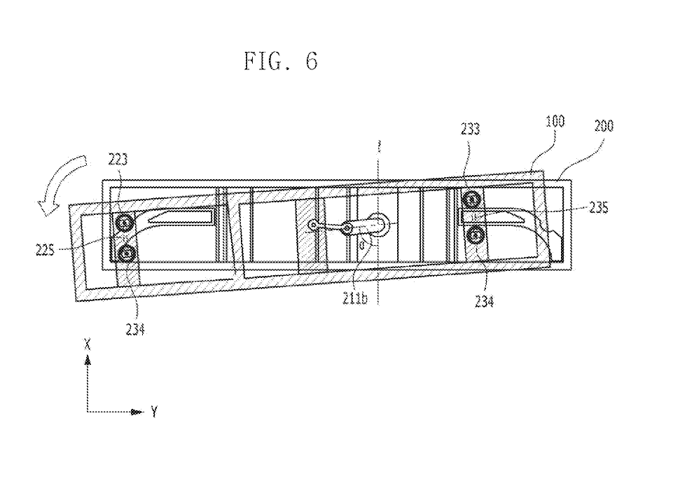

As described above, the driven part 100 is fastened in contact with the fixing pin, which is arranged at the uppermost end of the guide wheel. Referring to FIG. 1, the crank pin 221d gets in contact with the central lower end of the driven part 100 to transfer a driving force, and is fixed in contact with the lower end of the driven part 100 at other four spots through fixing pins so as to disperse the load and guide the motion of the driven part 100 stably. Referring to FIG. 4, the first guide wheels 223 and 224 and the second guide wheels 233 and 234 are located symmetrically from the center of the guide part 200 in the initial stop mode, but not in the initial position but in the swaying mode or the yawing mode, as shown in FIGS. 5 and 6, relative positions of the first guide wheels 223 and 224 and the second guide wheels 233 and 234 may not be symmetric with each other but deviate from the center of the guide part 200 to be varied.

In the meantime, the driving part 210 according to the first embodiment of the present invention is connected with a sway-yaw actuator 400, which is arranged inside the motion device, to be operated.

The sway-yaw actuator 400 may be arranged at a lower side relative to the guide part 200 but at an upper side relative to the lower plate 300. According to an embodiment, the driving part 210 may further include a damping part for controlling a rotational speed of the sway-yaw actuator 400, and a fixture for fixing the sway-yaw actuator 400. It should be understood, however, that there is no intent to limit the damping part and the fixture to the particular forms disclosed because they can be varied according to users' demands.

The cranks shaft 221a is connected to the sway-yaw actuator 400 to be rotated and is exposed to the upper part of the guide part 200. In this instance, for smooth rotation, the crank shaft 221a is combined to the guide part 200 by a bearing, and such configuration may be applied to the crank pin 211d connected with the driven part 100 in the same way or in similar ways.

The sway-yaw actuator 400 operates in correspondence with a control modes including at least one of: a swaying mode that the crank arm included in the crank module is actuated within a range of a first set angle (−θ₁ to +θ₁) such that the driven part 100 reciprocates in a straight line; a yawing mode that the crank arm is actuated within a range of a second set angle (−θ₂ to −θ₃ or +θ₃ to +θ₂) such that the driven part 100 shakes horizontally; and a composite mode that the crank arm is actuated within a range of a third set angle (−θ₄ to +θ₄) such that the driven part 100 carries out the swaying motion and the yawing motion at the same time.

For instance, when the crank arm moves one circulation cycle within the first set angle (−20 degrees to +20 degrees), the driven part 100 carries out the swaying motion. When the crank arm moves one circulation cycle within the second set angle (−70 degrees to −30 degrees or +30 degrees to +70 degrees), the driven part 100 carries out the yawing motion. Additionally, when the crank arm moves one circulation cycle within the first set angle (−70 degrees to +70 degrees), the driven part 100 carries out the swaying motion and the yawing motion together at one stroke of the crank arm (or at the same cycle). For your reference, the marks of + and − may be determined based on the virtual lines ‘1’ (in the width direction of the guide part) illustrated in FIGS. 4 to 6. It should be understood, however, that the embodiments are just exemplary embodiments for convenience in description.

In the meantime, the sway-yaw actuator 400 according to the embodiment of the present invention may be integrated in the driving part 210 to carry out the above functions. Also in the second, third and fourth embodiments, the sway-yaw actuator may be integrated in the driving parts 210B, 210C and 210D.

Next, referring to FIGS. 4 to 6, the motions that the driven part 100 can carry out by the driving part 210A according to the first embodiment and the control modes by motions will be described in detail.

FIG. 4 is a view showing a stop mode of the guide part and a driven part according to an embodiment of the present invention. FIG. 5 is a view showing the guide part and the driven part in a swaying mode according to an embodiment of the present invention. FIG. 6 is a view showing the guide part and the driven part in a yawing mode according to an embodiment of the present invention.

Referring to FIG. 4, in a stop mode that the sway-yaw actuator 400 does not operate, the guide part 200 and the driven part 100 are in an overlapped condition.

When an angle a between the reference line 1 and the first piece 211b of the crank arm does not reach the first set angle (−θ₁ to +θ₁), the motion device is in the stop mode. Because the crank module 211 is mounted to deviate from the center of the guide part 200 and the cranks shaft 211a also deviates from the center of the guide part 200, as shown in FIG. 4, a predetermined angle difference is formed between the reference line ‘1’ and the first piece 211b of the crank arm even in the stop mode.

Referring to FIG. 5, the motion device can control the driven part 100 to carry out the swaying motion (shaking from side to side) because the sway-yaw actuator 400 operates to rotate the crank arm in a predetermined direction.

In detail, when the angle between the reference line 1 and the first piece 211b of the crank arm becomes larger or smaller than the initial angle, the driven part 100 is shaken from side to side. In the case that the angle between the reference line 1 and the first piece 211b of the crank arm is controlled to be within the range of the first set angle (−θ₁ to +θ₁), when the sway-yaw actuator 400 operates, the swaying motion is carried out.

Therefore, the sway-yaw motion device according to the present invention can provide an audience with a motion effect such that the audience feels as if he or she does a reciprocating linear action in the predetermined direction. In this instance, the control mode of the sway-yaw actuator 400 may be set to a linear motion mode.

Referring to FIG. 6, the motion device can control the driven part 100 to carry out the yawing motion (horizontal shaking) because the sway-yaw actuator 400 operates to rotate the crank arm more in the predetermined direction.

Like FIG. 5, when the angle between the reference line 1 and the first piece 211b of the crank arm becomes larger or smaller than the initial angle, the driven part 100 carries out horizontal shaking. In this instance, a workable angle of the crank arm may be called the second set angle (−θ₂ to −θ₃ or +θ₃ to +θ₂).

Here, because the second piece 211c of the crank arm spreads to be almost parallel to the first piece 211b, the working range of the guide wheel increases.

Therefore, the sway-yaw motion device according to the present invention can provide an audience with a motion effect such that the audience feels as if he or she does a reciprocating curvilinear action in the predetermined direction. In this instance, the control mode of the sway-yaw actuator 400 may be set to a curvilinear motion mode.

When the crank arm actuates within the range of the third set angle (−θ₄ to +θ₄) by controlling the angle a of the crank arm, the driven part 100 may carry out the swaying motion and the yawing motion at one stroke of the crank arm (or at the same time).

Referring to FIG. 6, the swaying motion is carried out when the second guide wheels 233 and 234 locate at the right run on the straight line zone of the guide rail, and the yawing motion is carried out when the first guide wheels 223 and 224 located at the left run on the curved zone of the guide rail. Therefore, in the control mode of the sway-yaw actuator 400, the curvilinear motion mode and the linear motion mode can be carried out together.

In an aspect of consecutive motions, the sway-yaw motion device according to the present invention can carry out a swaying-swaying motion, a yawing-yawing motion, and a swaying-yawing motion. The swaying-swaying motion means that the driven part maintains swaying in a swaying state, the yawing-yawing motion means that the driven part maintains yawing in a yawing state, and the swaying-yawing motion means that the driven part consecutively converts motions from the swaying state into the yawing state or from the yawing state into the swaying state.

In the meantime, the chair assembly according to an embodiment of the present invention includes the above-mentioned motion device, a seat for allowing the audience to sit thereon, a lower plate 300 arranged below the guide part 200 to support the guide part 200, and at least two actuators mounted on the lower plate 300 to provide pitching, rolling and heaving motions. According to an embodiment, as shown in FIG. 1, in order to carry out the pitching motion, the rolling motion and the heaving motion, there are two first actuators 310 and 320 and a second actuator 330.

The chair assembly according to the present invention includes the lower plate illustrated in FIG. 1, and the first actuators 310 and 320 and the second actuator 330 mounted therein to carry out X-axis rotation, Y-axis rotation and Z-axis movement. In addition, according to embodiments, components which provide additional functions, for instance, to prevent vibration or noise by load disturbance, may be further included.

Accordingly, the chair assembly according to the present invention can additionally provide the swaying motion, which is a linear motion on the plane, and a yawing motion, which is a rotary motion on the plane, as well as the pitching motion, the rolling motion and the heaving motion.

Therefore, the chair assembly with the sway-yaw motion device according to the present invention can secure various degrees of freedom (five degrees of freedom) capable of carrying out all motions on space, and provide the audience with the optimum and realistic motion effects.

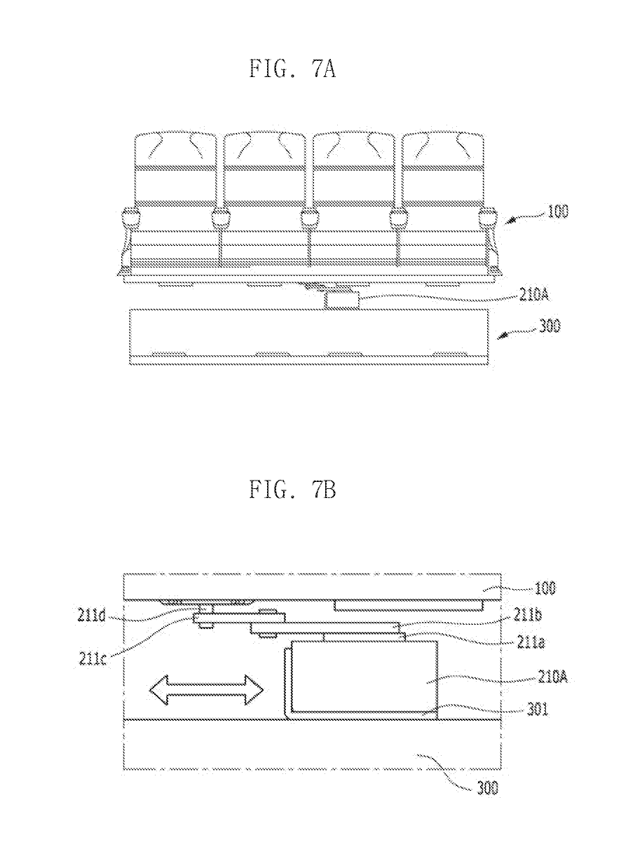

Finally, referring to FIGS. 7A to 10B, the driving part according to other embodiments of the present invention will be described.

FIGS. 7A and 7B are a conceptual diagram of a driving part according to a first embodiment of the present invention illustrated in FIG. 2, FIGS. 8A and 8B are a conceptual diagram of a driving part according to a second embodiment of the present invention, FIGS. 9A and 9B are a conceptual diagram of a driving part according to a third embodiment of the present invention, and FIGS. 10A and 10B are a conceptual diagram of a driving part according to a fourth embodiment of the present invention.

FIGS. 7A and 7B illustrate the crank-drive driving part according to the first embodiment, and is described above. According to the first embodiment, when the angle of the crank arm is varied, the position of the driven part 100 connected to the crank pin is changed so as to carry out the swaying-yawing mode.

The driving part according to another embodiment of the present invention includes a power generation part and a shaft, which is connected to the power generation part and moves to be parallel to the longitudinal direction of the guide part 200. The second embodiment is different from the first embodiment in that the driven part is moved not when the angle of the crank arm is varied but when the shaft is actuated.

The shaft is connected with a connection member 101 downwardly extending from the driven part so as to offer linear driving power to the driven part.

Referring to FIGS. 8A and 8B, In detail, the driving part is the cylinder-drive driving part 210B in the second embodiment, the linear motor-drive driving part 210C in the third embodiment, and the screw motor-drive driving part 210D in the fourth embodiment of the present invention.

In the cylinder-drive type according to the second embodiment, the shaft connected to a hydraulic or pneumatic cylinder carries out a linear motion to vary the position of the driven part 100. The driven part 100 receives power in the left direction or right direction of FIGS. 8A and 8B by actuation of the shaft so as to carry out the swaying-yawing motion by the guide module. In this instance, the hydraulic or pneumatic cylinder may be fixed by a fixing member 301 disposed on the upper part of the lower plate 300.

Referring to FIGS. 9A and 9B, In the linear motor-drive type according to the third embodiment, the shaft connected to a linear motor carries out a linear motion to vary the position of the driven part 100. The driven part 100 receives power in the left direction or right direction of FIGS. 9A and 9B by actuation of the shaft so as to carry out the swaying-yawing motion by the guide module. In this instance, the linear motor may be fixed by a fixing member 301 disposed on the upper part of the lower plate 300.

Referring to FIGS. 10A and 10B, In the screw motor-drive type according to the fourth embodiment, the shaft connected to a screw motor (linear type screw motor) carries out a rotary motion to vary the position of the driven part 100. The driven part 100 receives power in the left direction or right direction of FIGS. 10A and 10B by actuation of the shaft so as to carry out the swaying-yawing motion by the guide module. In this instance, the screw motor may be fixed by a fixing member 301 disposed on the upper part of the lower plate 300. In the fourth embodiment, because the driven part is moved using the rotary power of the screw motor, one of at least two fixing members 301 fixes the screw motor and the other fixing member fixes one end of a screw.

The driving part of the present invention is not limited to the first to fourth exemplary embodiments of the present invention. In the case that the guide module is mounted to provide the audience with the motion effect of the swaying-yawing mode, it should be understood that all cases in which the driven part can be moved straightly in the right-and-left direction are included in the scope of the present invention.

As described above, the sway-yaw motion device and the chair assembly with the same according to the embodiments of the present invention are described. Those skilled in the art will understand that the present invention can be implemented as other concrete forms without changing the inventive concept or essential features. Therefore, these embodiments as described above are only proposed for illustrative purposes and do not limit the present invention.

When a component is said to be “connected to” or “accessing” another component, it is to be appreciated that the two components can be directly connected to or directly accessing each other but can also include one or more other components in-between. In the entire specification of the present disclosure, when any member is located “on” another member, this includes a case in which still another member is prevent between both members as well as a case in which one member is in contact with another member. Additionally, “connection” includes a direct connection and an indirect connection between one member and another member, and may mean all physical connection, such as bonding, attachment, coupling, combination, binding, and so on.

In the various exemplary embodiments of the specification, the terms, “first”, “second”, and the like are used to describe various constituent elements, but do not limit the order or other characteristics.

As used herein, the singular forms are intended to include the plural forms as well, unless the context clearly indicates otherwise. It will be understood that the terms “comprises” and/or “has,” when used in this specification, specify the presence of a stated feature, number, step, operation, component, element, or combination thereof, and may be interpreted as addition of one or more other features, numbers, steps, operations, components, elements, or combinations thereof.

Therefore, the above embodiments should be understood as being descriptive, not limitative in all aspects.

1. A sway-yaw motion device comprising:
a guide part;
a driving part arranged in an inner space of the guide part; and
a driven part selectively carrying out motions according to one of a swaying mode, a yawing mode and a swaying-yawing composite mode by the driving part.

2. The sway-yaw motion device according to claim 1, wherein the driving part makes the driven part carry out a linear motion in a parallel direction to a longitudinal axis of the guide part in the case of a swaying mode, and makes the driven part carry out eccentric rotation on a vertical axis of the guide part in the case of a yawing mode.

3. The sway-yaw motion device according to claim 1, wherein the guide part comprises at least one guide module for inducing the swaying mode and the yawing mode of the driven part.

4. The sway-yaw motion device according to claim 3, wherein the guide module comprises:
a guide rail mounted in the inner space of the guide module; and
guide wheels, which support the load of the driven part 100 and move in contact with the guide rail.

5. The sway-yaw motion device according to claim 4, wherein the guide wheel comprises a front wheel located on the front surface of the guide rail and a rear wheel located on the rear surface of the guide rail.

6. The sway-yaw motion device according to claim 5, wherein a guide rod for connecting the front wheel and the rear wheel with each other is inserted into the guide rail.

7. The sway-yaw motion device according to claim 3, wherein a pair of guide modules are arranged with line symmetry on the basis of the width direction from the center of the guide part.

8. The sway-yaw motion device according to claim 1, wherein the driving part comprises:
a crank shaft;
crank arms connected from an end portion of the crank shaft in the horizontal direction along one side of the guide part; and
a crank pin formed to extend vertically from the crank arm and connected to the driven part.

9. The sway-yaw motion device according to claim 8, wherein the crank arms are formed by at least two pieces, which are linked with each other.

10. The sway-yaw motion device according to claim 8, wherein the crank arms move the driven part through an angular variation of the crank arms relative to the width direction of the guide part so as to convert the swaying mode into the yawing mode and the yawing mode into the swaying mode.

11. The sway-yaw motion device according to claim 8, wherein in the case that the crank arms are actuated at more than a predetermined angle range relative to the width direction of the guide part, the swaying mode and the yawing mode with respect to the driven part are carried out at the same time.

12. The sway-yaw motion device according to claim 1, wherein the driving part comprises a power generation part and a shaft, which is connected to the power generation part and moves to be parallel to the longitudinal direction of the guide part.

13. The sway-yaw motion device according to claim 12, wherein the shaft is connected with a connection member downwardly extending from the driven part so as to offer linear driving power to the driven part.

14. A chair assembly with a sway-yaw motion device comprising:
a driven part having a seat for allowing an audience to sit thereon;
a guide part arranged below the driven part;
a driving part arranged in an inner space of the guide part to make the driven part selectively carry out motions according to one of a swaying mode, a yawing mode and a swaying-yawing composite mode; and
a lower plate for supporting the guide part,
wherein at least two actuators for inducing pitching, rolling and heaving motions are arranged on the lower plate.

15. The chair assembly according to claim 14, wherein the driving part makes the driven part carry out a linear motion in a parallel direction to a longitudinal axis of the guide part in the case of a swaying mode, and makes the driven part carry out eccentric rotation on a vertical axis of the guide part in the case of a yawing mode.
